(19) United States
(12) Patent Application Publication
(10) Pub. No.: US 2004/0123883 A1
(43) Pub. Date: Jul. 1, 2004

(54) Method and apparatus for producing fused tube on bag and bag produced thereby

(75) Inventors: Barry Pritchard, Nazareth, PA (US); Lawrence D. Bush, Nazareth, PA (US); Leon Henry, Palmerton, PA (US); Richard Good, Mohnton, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: AFP advanced food products llc, New Holland, PA

(21) Appl. No.: 10/666,471

(22) Filed: Sep. 19, 2003

Related U.S. Application Data
(60) Provisional application No. 60/411,842, filed on Sep. 19, 2002.

(51) Int. Cl. B08B 3/00

(52) U.S. Cl. 134/63

(57) ABSTRACT

An apparatus for attaching a tube segment to a bag by fusing them together in an aseptic form, fill and seal operation is provided. The apparatus includes a sterile processing chamber in which a sterilized tube segment and a pair of opposing wall portions of a flexible bag are to be located. The sterilized tube segment has an open end which is to be placed in communication with an interior space of the bag. A tube inserter is at least partially located within the processing chamber and arranged to grip the tube segment and place the tube segment between the wall portions of the bag. At least one member is provided for fusing the tube segment between the wall portions of the bag so that the open end of the tube segment is in communication with the interior space in the bag. A bag formed using the apparatus and a method of forming the fused tube-on-bag are also provided.

### CROSS-REFERENCE TO RELATED APPLICATIONS

This application claims the benefit of U.S. Provisional Application No. 60/411,842, filed Sep. 19, 2002.

### BACKGROUND

The present invention is directed to flexible pouches or bags, and apparatus and methods for making them and in particular to food storage and dispensing bags used in connection with viscous or semi-viscous food and drinks and apparatus and methods for making them.

It has been known in the art to use flexible plastic bags in connection with the packaging, shipping and dispensing of viscous or semi-viscous food materials and drinks, including milk, soda, juices, various sauces, such as cheese sauce, tomato sauce, chocolate sauce, and various other suitable food products. The flexible plastic bags can be formed with a dispensing spout that is part of the bag material itself, such as by heat sealing a spout shape into the bag itself. After being filled and sealed with a desired viscous of semi-viscous material, the bag can then be loaded into an appropriate dispenser and the spout cut open for controlled discharge of the bag contents.

It is also known to use a fitment that can be heat sealed or otherwise adhered to a side or bottom of a flexible plastic pouch. A dispensing tube may be connected to the fitment prior to use, depending upon the particular application. The bag contents can then be dispensed through the fitment using an appropriate dispenser.

A particular problem is producing an inexpensive, easily mass produced connection between a dispensing tube and a bag which provides a firm connection to the bag without a fitment, and which can be used in an aseptic bag forming and filling process. While it has been suggested to attach a dispensing tube directly to a bag, there has been no disclosure of how this can be accomplished in an aseptic packaging environment where, in additional to the known aseptic forming of the bag, the dispensing tube would also have to be handled and attached in an aseptic manner.

### SUMMARY

Briefly stated, the invention provides an apparatus for attaching a tube segment to a bag by fusing them together in an aseptic form, fill and seal operation. The apparatus includes a sterile processing chamber in which a sterilized tube segment and a pair of opposing wall portions of a flexible bag are to be located. The sterilized tube segment has an open end which is to be placed in communication with an interior space of the bag. The opposing wall portions of the flexible bag are formed from a film and define the interior space therebetween. A tube inserter is at least partially located within the processing chamber and arranged to grip the tube segment and place the tube segment between the wall portions of the bag in the sterile processing chamber. At least one member is provided for fusing the tube segment between the wall portions of the bag so that the open end of the tube segment is in communication with the interior space in the bag.

In another aspect, the invention provides a flexible bag with a directly connected dispensing tube connected under aseptic conditions. The bag includes a polymeric bag formed of a polymeric film having two wall portions overlying one another and connected together via a fold which forms a common connected, non-seamed edge. A plurality of other common peripheral edges are fused together to form edge seams of the bag. The wall portions, the edge seams and the non-seamed edge define an interior space of the bag. A sterile tube segment having an open end is inserted between the two wall portions of the bag film along one of the common peripheral edges and secured thereto by a fused joint created under aseptic conditions prior to or during formation of the edge seam. The open end of the tube is in communication with the interior space, and the tube has a closed end, located outside of the bag film.

In another aspect, the invention provides a method of attaching a tube to a bag by fusion during manufacture in an aseptic form, fill and seal operation. The method includes:

providing a film having two wall portions for forming a bag with an interior space;

providing a sterile tube segment having an open end;

inserting the open end of the tube segment between the wall portions; and

fusing the tube segment to the bag with the open end of the tube in communication with the interior space.

By utilizing the apparatus and method of the invention, it is possible to create a dispensing tube fused directly to a bag in an aseptic environment, which is preferably used in connection with an aseptic form, fill and seal food packaging operation for viscous or semi-viscous food or drink products. This eliminates the requirement for a fitment as well as the associated cost and extra fitment handling steps required during such operations. This results in reduced cost and more efficient processing.

### BRIEF DESCRIPTION OF THE DRAWING(S)

The foregoing Summary and the following detailed description will be better understood when read in conjunction with the following drawings, which illustrate preferred embodiments of the invention. In the drawings:

FIG. 1A is a perspective view of a roll of tubing with a sterile interior and crimped at both ends which is used to form tube segments which are attached to a flexible bag in accordance with the present invention.

FIG. 1B is a perspective view of a roll of pre-crimped tubing having a plurality of connected, pre-crimped tube segments, each having a separate, sterile interior space, which is used to form the tube segments which are attached to a flexible bag in accordance with the present invention.

FIG. 1C is a side view of a container holding a supply of sterilized tube segments, each tube segment having one open end and one closed end, which are attached to a flexible bag in accordance with the present invention.

FIG. 2 is a diagrammatic view of a system for attaching a tube segment to a bag as it is being formed in accordance with a first embodiment of the invention.

FIG. 3 is a diagrammatic side view of a system for attaching a tube segment to a bag as it is being formed in accordance with a second embodiment of the invention.

FIG. 4 is a side view of a system for attaching a tube segment to a bag as it is being formed in accordance with a third embodiment of the present invention.

FIG. 5 is a top view of the system of FIG. 4.

FIG. 6 is an enlarged side view of the tubing supply unwind stand shown in FIG. 4.

FIG. 7 is an enlarged side view of the sterilizing bath shown in FIG. 4.

FIG. 8 is an enlarged side view of the gripper and cutter section of the system shown in FIG. 4.

FIG. 9 is a view taken along line 9-9 of FIG. 8 showing the cutter/preheat jaws.

FIG. 10 is an enlarged side view of the tube segment inserter and heat sealing jaws.

FIG. 11 is a view taken along line 11-11 of the film spreader.

FIG. 12 is a top view of the cutter and inserter.

FIG. 13 is a side view of the full fin heat sealing jaws.

FIG. 14 is an enlarged side view of one of the full fin heat sealing jaws.

FIG. 15 is an end view taken along line 15-15 in FIG. 14.

FIG. 16A is an enlarged side view of one of the tube to bag only heat sealing jaws.

FIG. 16B is a view similar to FIG. 16A showing an alternate recess configuration of a heat sealing jaw.

FIG. 17 is a top view taken along line 17-17 in FIG. 16.

FIG. 18 is a side view of a tube assembly used in connection with an alternate method of attaching a tube to a flexible bag in accordance with the present invention.

FIG. 19 is a side view illustrating the method of attaching the tube of FIG. 3 to the bag as it is being formed.

FIG. 20 is a cross-sectional of a barbed attachment piece used in connection with another embodiment of the present invention.

FIG. 21 is a side view of the barbed attachment piece of FIG. 20 shown in a sealed bag of a viscous or semi-viscous material.

FIG. 22 is a cross-sectional view showing the attachment of a tube to the flexible bag in FIG. 21 using the barbed attachment piece.

FIG. 23 is a perspective view of the preferred bag with a fused on dispensing tube formed in accordance with the present invention.

FIG. 24 is a cross-sectional view taken through the bag shown in FIG. 23.

### DETAILED DESCRIPTION OF THE PREFERRED EMBODIMENT(S)

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the flexible bag or the processing equipment shown and designated parts thereof. The terminology includes the words above specifically mentioned, derivatives thereof and words of similar import. Additionally, the term “bag” as used herein encompasses pouches and other types of containers formed with one or more flexible polymeric wall portions.

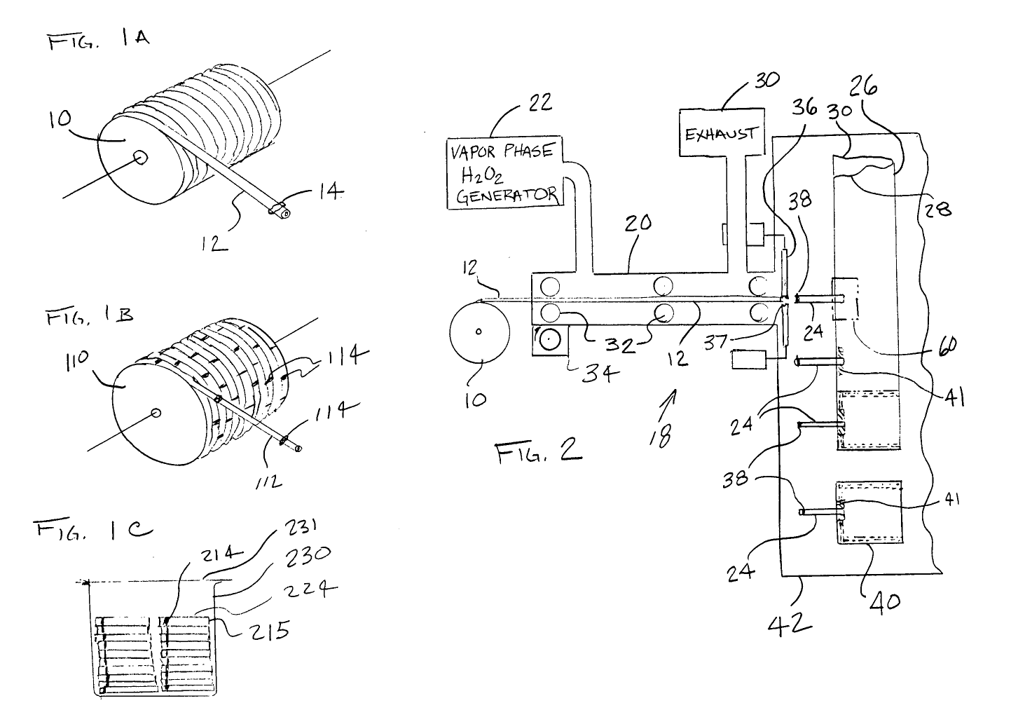

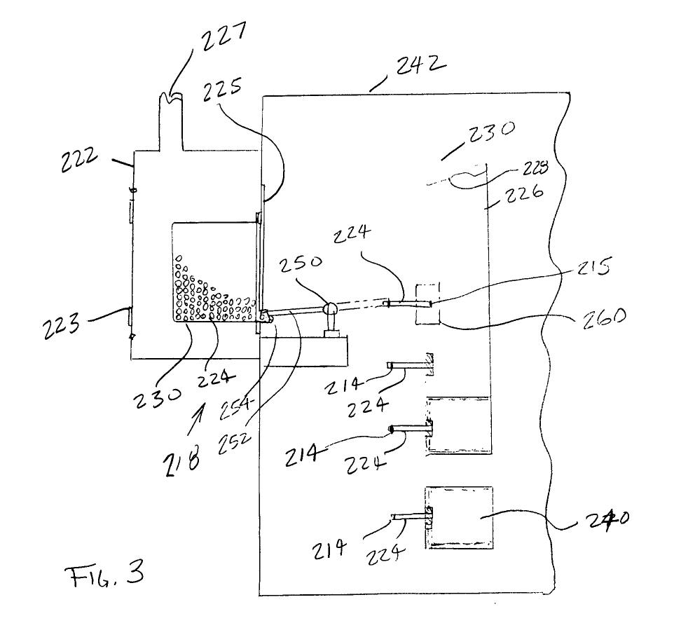

Referring now to FIG. 1A, a spool 10 of an extruded polymer tubing 12 is shown that is adapted for use in forming a dispensing tube segment 24 for an apparatus 18 in accordance with the invention, as shown in FIG. 2. The tubing 12 can be made of any suitable polymeric material, and is preferably food grade, and suitable for use in a peristaltic pump or gravity feed, pinch tube valve type dispensers. Each end of the tube 12 on the spool 10 is crimped or otherwise hermetically sealed, as indicated on the exposed end at 14. The spool 10 with the tubing 12 is then irradiated or otherwise treated to ensure sterility of the internal tube surfaces. The sealed ends maintain the sterility of the inside of the tube 12. This is preferably also monitored and tested in order to ensure compliance with applicable FDA or other regulations regarding food packaging.

Alternatively, referring to FIG. 1B, a spool 110 of pre-crimped tubing 112 is shown that is used to form the tube segment 124. The crimp locations 114 are generally uniformly spaced at a desired tube segment length. The tubing 112 is then irradiated or otherwise treated to ensure sterility of the internal tube surfaces for each of the separately sealed inner tube segment areas. While this is shown as being wound on a spool, those skilled in the art will recognize from the present disclosure that it could also be provided in a fan-folded or other type of supply arrangement.

As shown in FIG. 1C, it would also be possible to provide tube segments 224, made of an appropriate polymeric material, that have been pre-cut to the desired lengths. One end 214 of each tube segment 224 is pre-sealed or crimped and the other end is open. The tube segments 224 are provided in a sterile container 230, including an openable cover 231, that is adapted to be connected to or loaded into a sterile environment while maintaining sterility, as explained in further detail below.

In accordance with a first embodiment of the invention, an apparatus 18 for producing a fused tube on bag is provided, as shown in FIG. 2, which utilizes the spool 10 of the tubing 12. The apparatus 18 preferably includes a tube sterilization chamber 20 to which an H₂O₂ (hydrogen peroxide) vapor generator 22 is attached in order to sterilize an outer surface of the tubing 12. However, other means could be used to provide or maintain the sterility of the tubing supply or pre-sterilized tube segments 24. For example, a UV light, an H₂O₂ bath, steam/H₂O₂ mix or other appropriate sterilization system can be used in the chamber 20 in place of the H₂O₂ vapor, if desired. Maintaining sterility in the chamber 20 is important so that the inner tube surface sterility is maintained as the tubing 12 is cut into tube segments 24. An appropriate seal is provide at the entrance of the tubing 12 into the chamber 20, such as a diaphragm with an appropriately sized opening, and the H₂O₂ vapor is maintained at a positive pressure to maintain sterility. An exhaust duct 30 leads from the chamber 20.

The continuous tubing 12 is fed via drive rollers 32 driven by a motor 34, preferably a servo motor to a cutter/sealer assembly 36. The end of the tubing 12 extends past the cutter 36 and the open end is inserted between the wall portions 28, 30 of the bag film 26 (which are preferably folded over one another) that are used to make the bag 40. The initial end of the tubing 12 from the spool 10 will need to be cut first so that an open end of the tubing 12 can inserted between the wall portions 28, 30 as the first bag 40 is formed. The cutter 36 then cuts the tubing 12 into a separate tube segment 24, and holds the tube segment 24 in position. The cutter 36 preferably includes cutting jaws 37 that are driven together via actuators. The cutting jaws 37 are preferably heated so that one end 38 of the tube segment 24 is sealed shut. However, other sealing methods could be used. A controller (not shown) controls the motor 34 so that consistent lengths of the tube 12 are fed to the cutter/sealer assembly 36. The tube segment 24 is then fused between the wall portions 28, 20 to form a fused area 41 so that the open end of the tube segment 24 is in communication with an interior bag space. This is preferably done by heat sealing using opposing heat sealing jaws 60. However, ultrasonic energy or a laser may be used, as well as any other suitable means to fuse the tube material to the bag film 26.

The bag 40 with the attached dispensing tube 24 then completes the remainder of the fill and sealing operations in an aseptic form, fill and seal process. This allows a viscous or semi-viscous food product to be aseptically packaged in a bag 40 with a dispensing tube 24 in a cost effective and efficient manner.

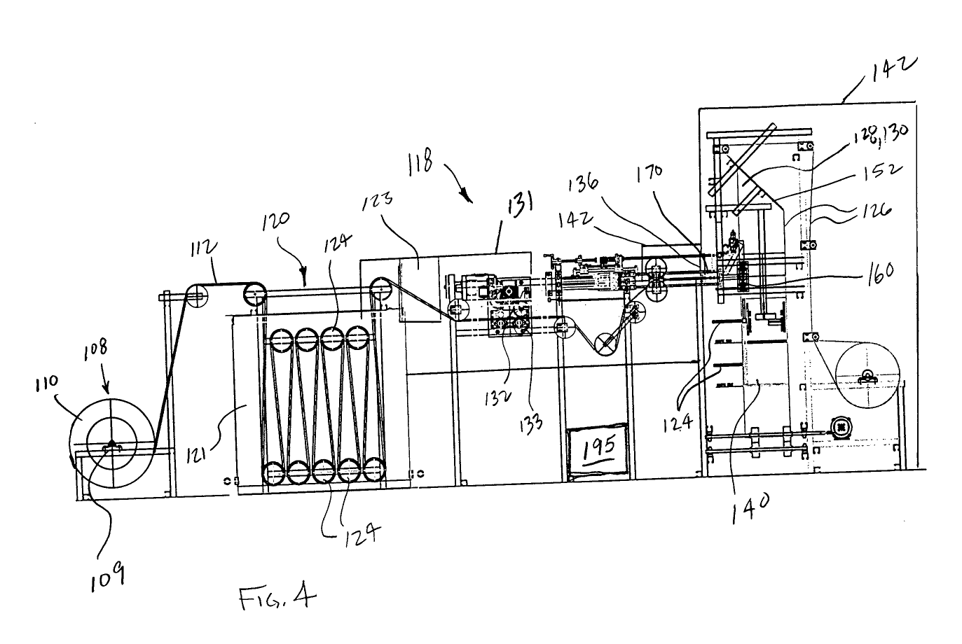

Referring now to FIG. 3, a second apparatus 218 for attaching a tube segment 224 to a bag 240 by fusing them together in an aseptic form, fill and seal operation is shown. The tube segments 224, preferably as shown in FIG. 1C, are supplied pre-cut to the desired length and pre-sealed at one end. These tube segments 224 are sterilized and held within a sterile container 230. The tube segments 224 are preferably introduced into the sterile processing chamber 242. A tube inserter 250, located at least partially within the processing chamber 242, is arranged to grip each tube segment 224 and place the tube segment 224 between the wall portions 228, 230 of the bag film 226 used to form the bag 240. At least one member 260 for fusing the tube segment 224 between the wall portions 228, 230 of the bag 240 is provided so that an open end of the tube segment 224 is in communication with the interior space of the bag 240. The at least one fusing member 260 can be at least one heat sealing jaw which is movable against a fixed jaw, or two movable heat sealing jaws which are moved and clamped together to heat seal and fuse the bag film to the outside of the tube segment 224 in proximity to the open end 215. Other fusing methods can be utilized, as discussed in connection with the apparatus 18 above.

In the preferred embodiment, a loading chamber 222 is attached to the sterile processing chamber 242 in order to introduce the containers 230 of sterilized tube segments 224 into the sterile processing chamber 242 while maintaining sterility. This can be done by providing a hatch 223 in the loading chamber 222 to allow a container 230 to be loaded. The hatch 223 can then be resealed and the exterior of the container 230 sterilized via various means, such as through the introduction of a vapor phase hydrogen peroxide provided via inlet 227. Once the exterior of the container 230 has been sterilized, an inner door 225 leading to the sterile processing chamber 242 can be opened, and the container cover 231 can be partially or fully opened. The tube segments 224 can then be fed into a hopper or otherwise positioned so that they can be gripped by the inserter 250. The inserter 250 preferably comprises a movable arm 252 having a gripper 254 located on one end. The arm 252 preferably is capable of two or more degrees of freedom of movement via actuators with appropriate drives and pivotable or sliding connections, and is preferably controlled via a controller (not shown), so that it grips a tube segment 224 and correctly inserts it between the wall portions 228, 230 of the bag film 226 used to form the bag 240. Various other types of mechanisms could also be used to grip and insert the tube segments 224.

Those skilled in the art will recognize that other means may be used for loading the pre-sterilized tube segments 224 into the sterile processing chamber 242, or that the tube segments 224 could pass through a sterilizing bath or vapor prior to entering the sterile processing chamber 242.

Referring now to FIGS. 4-14, another apparatus 118 for attaching a tube segment 124 to a bag 140 by fusing them together in an aseptic form, fill and seal operation is shown. The apparatus 118 includes a sterile processing chamber 142, into which the sterilized tube segment 124 is introduced. The sterilized tube segment 124 has an open end 115, shown in FIG. 8. A flexible bag 140 is formed in the sterile processing chamber 142 from opposing wall portions 128, 130 of the film 126 used to form the bag (hereinafter referred to as the “film” or the “bag film”), which define an interior space therebetween.

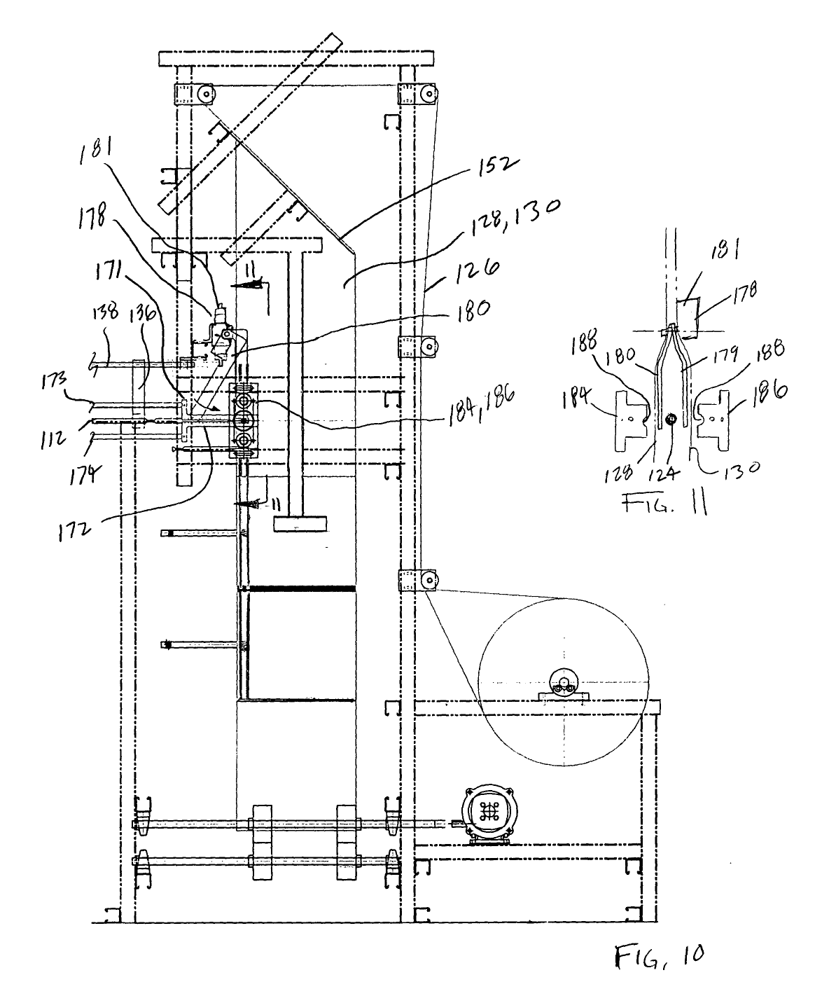

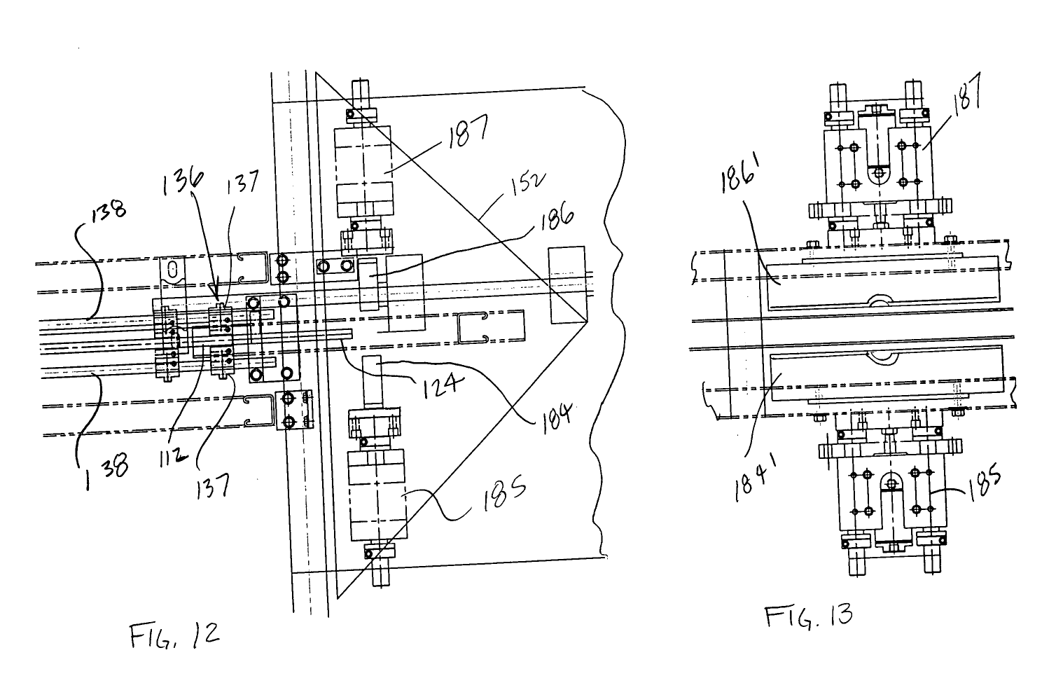

The bag film 126 is preferably supplied in roll form, and can be pre-sterilized or the bag film can be passed through a sterilizing area within or attached to the sterile processing chamber 142. Preferably, the bag film 126 passes over a folding triangle 152, shown most clearly in FIG. 12, or some other type of film folder, so that the opposing wall portions 128, 130 of the bag film overlie one another. A tube inserter 170 is located within the processing chamber 142, as shown in more detail in FIG. 8. The tube inserter 170 is arranged to grip the tube segment 124 and place the tube segment 124 between the wall portions 128, 130 of the bag film in the sterile processing chamber 142.

Preferably, at least one fusing member 160 is provided for fusing the tube segment 124 between the wall portions 128, 130 of the bag film 126, so that the open end of the tube segment 124 is in communication with the interior space in the bag 140.

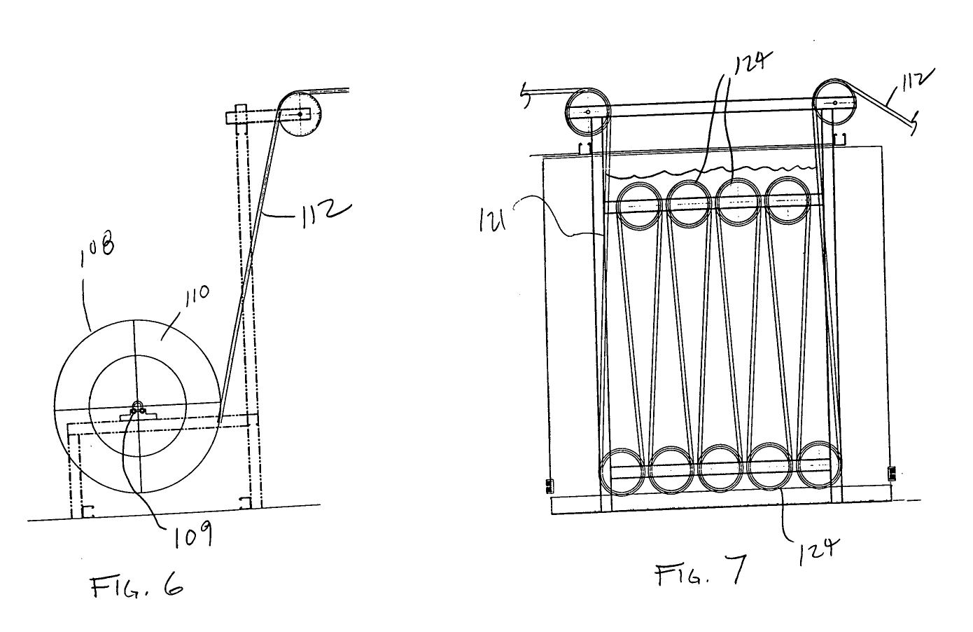

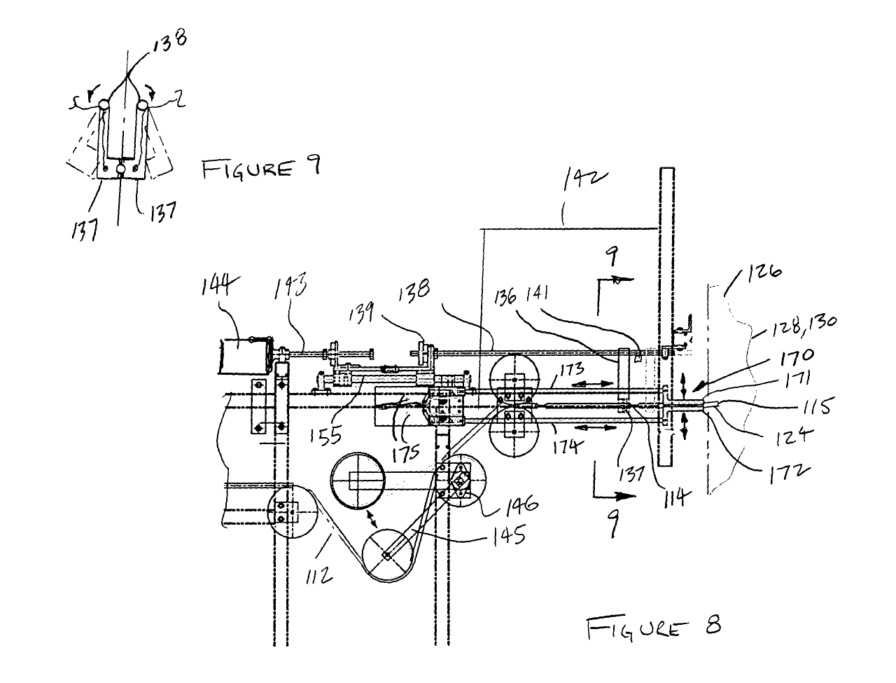

Referring to FIGS. 4 and 7, preferably a tube sterilization chamber 120 is provided, in which tubing 112 from a supply of tubing 108 is introduced. The tube sterilization chamber 120 is in communication with the sterile processing chamber 142 or may be part of the sterile processing chamber 142, depending on the particular arrangement. The sterile processing chamber 142 is an enclosed area which is pressurized at a positive pressure with sterile air in order to maintain an aseptic environment.

As shown in FIGS. 4 and 7, in the apparatus 118, the tube sterilization chamber 120 is a hydrogen peroxide bath 121. Preferably, a dryer 123 is located downstream of the bath 121, in which heated sterile air is blown on the tubing 112 to dry the outside. Preferably, the wall of the sterile area extends into the bath 121, as shown in FIG. 4, so that the tubing exiting the bath 121 is already within the sterile area. The dryer 123 is also located within or in communication with the sterile area and heats sterile air to dry the tubing 112. The heated air can be recirculated or exhausted.

Preferably, a plurality of rollers 124 are located in the bath 121. The tubing 112 extends between the rollers 124 to provide a desired dwell time in the bath to ensure sterility. Other alternatives exist for providing the desired dwell time in the bath 121 while maintaining a preferred operating speed of a form fill and seal system on the order of 30 to 60 bags per minute, such as extending the length of the bath 121 or providing a circuitous chamber.

Alternatively, the tube sterilization chamber 120 could include a hydrogen peroxide vapor generator connected to the sterile processing chamber 142 that feeds hydrogen peroxide vapor into the chamber 120, similar to the embodiment of the invention shown in FIG. 2. This has the advantage of providing positive pressure sterilization in the form of the hydrogen peroxide vapor. For the system using the hydrogen peroxide bath, the sterile air for the remainder of the sterile tube processing and cutting area would have to be supplied from an outside source of sterile air, or use the sterile air provided by the remainder of a form fill and seal equipment line.

When hydrogen peroxide vapor is used, it is preferred that the concentration be at least 31% hydrogen peroxide vapor in the air. While the preferred tube sterilization chamber 120 utilizes a hydrogen peroxide bath or vapor, it is also possible to use an ultraviolet radiation chamber, an ion radiation chamber, a high-intensity pulse light chamber or any other suitable means for the tube sterilization chamber 120.

Preferably, the apparatus 118 includes a tube supply unwind stand 109 with the supply of tubing 108, preferably in the form of the spool 110, as discussed above. The unwind stand 109 preferably includes a tension brake of a known type in order to keep tension on the tubing 112. This can be through a spring, ratchet and pawl mechanism or other suitable biasing means. Preferably, the apparatus 118 utilizes the pre-crimped, irradiated tubing 112, in which the inside area of the tubing 112 is sterile. Alternatively, the supply of tubing 108 could comprise the tubing 12, which is crimped only at each end, and the apparatus 118 could further include one or more pre-heat sections to preheat a portion of the tubing 12, and a crimper (not shown) located downstream of the preheater to crimp the tubing 12 into sealed tube segments. This could be done in connection with the cutter assembly 136 in a similar manner to the embodiment of the invention shown in FIG. 2.

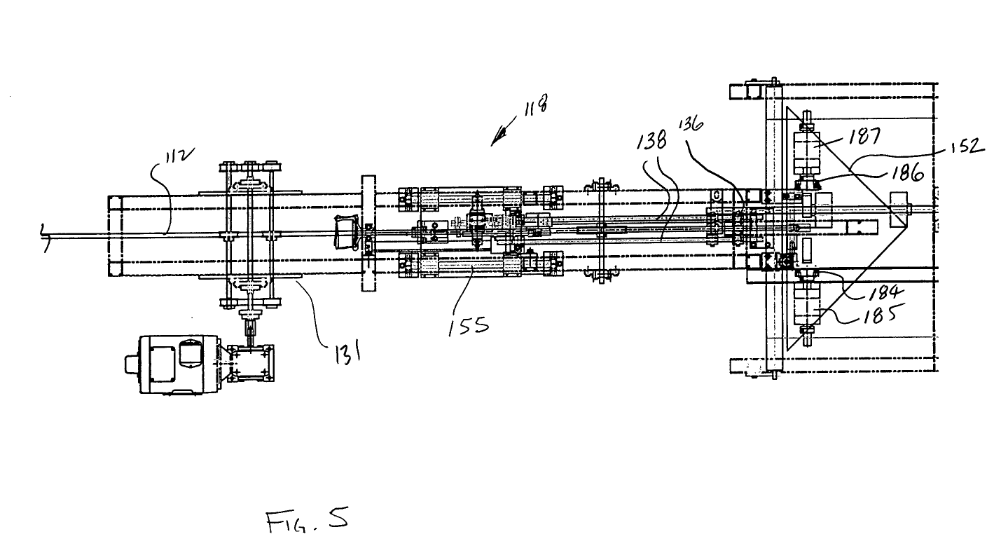

Referring to FIGS. 4 and 5, the apparatus includes a drive section 131, having a motor which drives opposing drive wheels 132, 133, which grip and pull the tubing 112 from the supply of tubing 108. Preferably, the drive wheels are driven by a stepper motor or other controllable drive arrangement so that the advancement of the tubing 112 from the supply of tubing 108 can be controlled. While two opposing drive wheels 132, 133 are preferred, additional drive wheels could be provided.

Referring now to FIGS. 4 and 8, the apparatus 118 further comprises a dancing bar 145 (FIG. 8) located in the path of the tubing 112. The dancing bar 145 is movable about a pivot point between upper and lower positions, and preferably includes a roller that contacts the tubing 112. A sensor 146 is connected to the dancing bar 145, which signals the drive wheels 132, 133 to feed additional tubing 112 when the dancing bar 145 approaches the upper position. The sensor 146 is preferably a potentiometer, and is connected to the controller 195. Other types of sensors could be utilized, such as a light beam sensor, the path of which is broken by the dancing bar 145 when it reaches an upper or lower limit position. Alternatively, other means of providing sufficient slack in the tubing 112 can be utilized, such as a slack loop in the tubing path with high and low limit sensors.

Still with reference to FIGS. 4 and 8, the cutter 136 is located in a sterile area within the sterile processing chamber 142. The cutter 136 cuts the tube segment 124 from the supply of tubing 112. As shown in FIG. 9, the cutter 136 preferably includes opposing blades 137 which are driven together to cut the tubing 112 into tube segments 124. The blades 137 are preferably connected to rotary shafts 138 which penetrate into the sterile processing chamber 142 through a sealable port. The rotary shafts 138 are driven by a rotary actuator 139, which is controlled by the controller 195. However, other types of actuators could be utilized, and the tube cutter 136 could be formed from a single cutting edge and anvil arrangement, depending on the properties of the tubing 112.

Preferably, a sensor 141 is provided to detect a position of a crimp 114 in proximity to the tube cutter 136. The crimp position sensor 141 is adapted to detect the adjacent crimp 114 and signals the controller 195 to allow a location of the cut to be positioned adjacent to the crimp 114. This is accomplished by mounting the tube cutter 136 for movement via an actuating screw 143 connected to a controllable motor 144. Preferably, the drive rods 138 and rotary actuator 139 are mounted on a sliding support arrangement 155, which can be moved back and forth via the actuating screw 143. Alternatively, other types of actuators could be utilized to move the sliding support 155 back and forth to adjust the position of the cutter 136 to a desired position behind the crimp 114 of the rightward most extending tube segment 124, as shown in FIG. 8.

Preferably, as shown in FIG. 12, the cutters 137 are preheated via heating elements located within the bodies of the cutters 137. As shown in FIG. 12, the cutters 137 include a tube engaging, pre-heating portion located to the left of the cutting edges which sever the tube segment 124 from the tubing 112. This gripping portion preheats an area around the open end of the tubing 112 for the next tube segment 124 prior to it being advanced forward and cut from the supply of tubing 112. This preheating of the area of the tube segment 124 adjacent to the open end enhances the bonding of the tube segment 124 to the bag film 126 during fusing.

Still with reference to FIG. 8, the inserter 170 comprises opposing jaws 171, 172 that are movable towards and away from one another to grip an end of the tubing 112 from the supply of tubing 108 prior to the tubing 112 being cut from the supply of tubing 108 to form the tube segment 124. The opposing jaws 171, 172 are connected to upper and lower actuator rods 173, 174, respectively, which are movable linearly towards and away from the bag film 126 in order to move the opposing jaws 171, 172 towards and away from the bag film 126. Preferably, the movement is accomplished via linear actuators 175 connected via the actuating rods 173, 174 to the jaws 171, 172. This allows the gripper 170 to insert the open end of the tube segment 124 between the sides 128, 130 of the bag film 126. As shown in FIG. 8, the actuating rods 173, 174 can also be tilted upwardly and downwardly in order to allow the jaws 171, 172 to be moved up or down to grip the end of the tubing 112 prior to the tube segment 124 being cut free. Preferably, the actuators 175 are located outside of the sterile processing area 142 and the actuating rods 173, 174 extend through appropriately sealed openings into the sterile processing area 142. While a preferred actuator arrangement has been described, those skilled in the art will recognize that other types of actuator arrangements can be used in order to provide the two jaws 171, 172 with both an opening and closing movement for gripping the tube segment 124, and a linear insertion movement to insert the open end of the tube segment between the opposing wall portions 128, 130 of the bag film 126. Additionally, it is preferred that the position and stroke length of the actuators 175 can be adjusted to provide a desired tube segment 124 gripping location and insertion distance.

Referring now to FIGS. 10 and 11, a bag film splitter 178 is located in the sterile processing area 142 and separates the opposing wall portions 128, 130 of the bag film 126 from one another at a tube insertion site prior to the inserter 170 placing the tube segment 124 in position. The bag film splitter 178 comprises two arms 179, 180 joined in a generally V-shaped arrangement, as shown in FIG. 11, that moves from a first position, in which only a first part of the arms 179, 180 at the base of the V are located, between opposing wall portions 128, 130 of the bag film 126 so that the bag wall portions 128, 130 are not generally separated, as shown at the upper part of FIG. 11, to a second position, in which the spaced apart ends of the arms 179, 180 are moved between and separate the bag wall portions 128, 130 to allow insertion of the tube segment 124 therebetween, as shown in the bottom half of FIG. 11. The first position is also clearly shown in FIG. 10, with the second position being shown in broken lines. The bag film splitter 178 is driven by an actuator 181 and is controlled via the controller 195.

Referring now to FIGS. 10-13, at least one heat sealing jaw 184, and preferably two heat sealing jaws 184, 186 are provided for heat sealing the tube segment 124 between the wall portions 128, 130 of the bag film 126. As shown in FIG. 12, the heat sealing jaws 184, 186 are connected to actuators 185, 187 in order to allow the heat sealing jaws 184, 186 to be movable from a first, non-contact position, away from the bag film 126, to a second, sealing position, in contact with the bag film 126 to seal the tube segment 124 between the wall portions 128, 130 of the bag film 126. The actuators 185, 187 are preferably controlled via the controller 195.

As shown in detail in FIGS. 11, 16 and 17, the heat sealing jaws 184, 186 include a recess 188, which is complementary to and smaller than a diameter of the tube segment 124. In the preferred embodiment, the recess is between 2 and 8 percent smaller in diameter than a corresponding diameter of the tube segment 124. Preferably, heating elements 189 and a temperature sensor 190 are provided in the heat sealing jaws 184, 186 in order to maintain the jaws at a desired temperature.

An alternate embodiment of the heat sealing jaws 184′, 186′ is shown in an end view in FIG. 13 and in detail in FIGS. 14 and 15, in which the heat sealing jaws 184′, 186′ also include a fin seal for an edge of the bag 140. In order to make the fin seal, the heat sealing jaws 184′, 186′, each include a plurality of heating zones that are controlled independently to provide a different heat sealing temperature in an area of the bag wall portion 128 to bag wall portion 130 seal from the bag wall portions 128, 130 to tube segment 124 seal. As shown in detail in FIG. 14, isolating air pockets 192 are provided around the jaw portion that houses the center heating element for the bag wall portions-to-tube segment seal. The center jaw portion can then be heated to a higher temperature in the area of the bag wall portions-to-tube segment seal. In a preferred embodiment, the heat sealing jaws 184′, 186′ are heated to 350-450° F. for heat sealing the bag sides 128, 130 to the tube segment 124, and from 250-350° F. for the bag side 128 to bag side 130 seal. More preferably, the range of temperatures for heat sealing the bag sides 128, 130 to the tube segment 124 is in the range of 400-430° F. and the heat in the bag side-to-bag side sealing in a range of 300-330° F. In the most preferred case, the set point temperature for the higher heating zone is set at 420° F. and the set point temperature for the lower heating zone is set at 320° F.

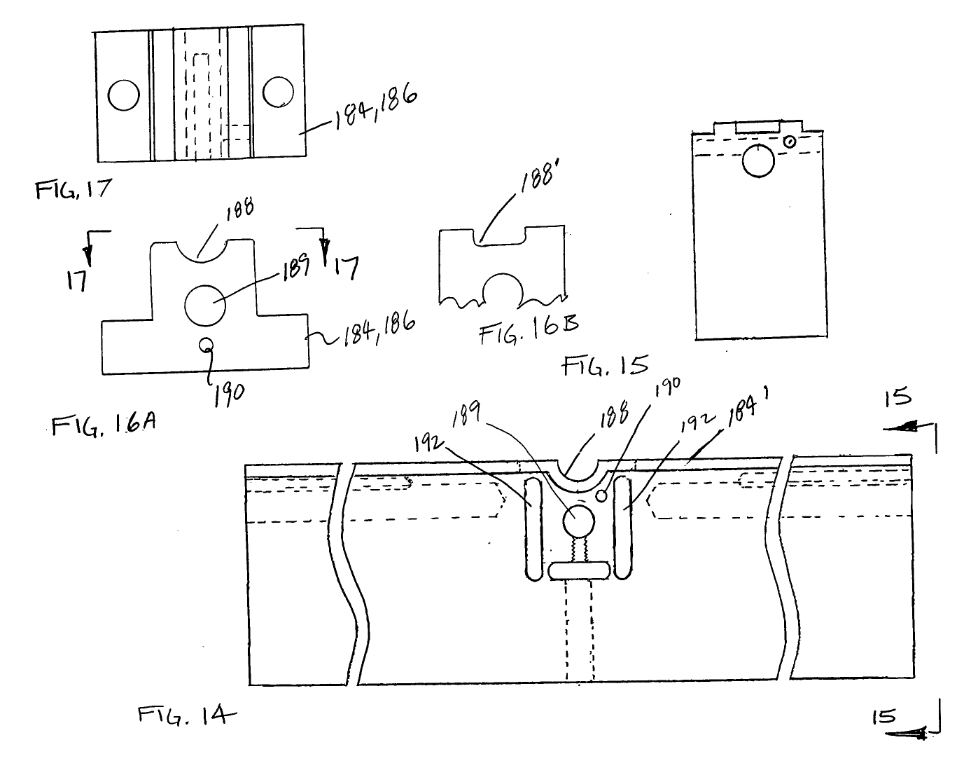

Referring now to FIG. 16B, it is also possible to provide the heat sealing jaws 184, 186 with a tube sealing recess 188′ having a flattened profile with a circumference that is smaller than a circumference of the tube segment 124. In this case, a generally rectangular profile having rounded corners has been found to be somewhat effective in that this forces additional tube deformation during sealing. Other suitable shapes for the recesses 188, 188′ could also include oval, square or diamond-shaped.

Preferably, the controller 195 is a PLC and is used to control a tube cut position, a tube feed rate, actuation of and a sealing temperature of the heat sealing jaws 184, 186, as well as the sealing time. The controller 195 can control all of these features and can provide adjustment in order to take into account various materials which may be used for the bag film 126 and/or the tubing 112.

As a safety feature in the event that the sterile environment in the sterile processing chamber 142 is compromised, the apparatus 118 can include a pressure sensor. If the sterile environment in the sterile processing chamber is breached, the pressure will drop. A tubing crimper, which crimps the tubing upon the pressure sensor detecting a loss of pressurization, is then be activated in order to maintain sterility of the remaining tubing 12 in a supply which is not pre-crimped along its entire length. This is not necessary with the pre-crimped tubing 112 because if the sterility is lost, the entire tubing 112 from the supply 108 is not compromised and only the very end segment having an open end could be exposed to a non-sterile environment.

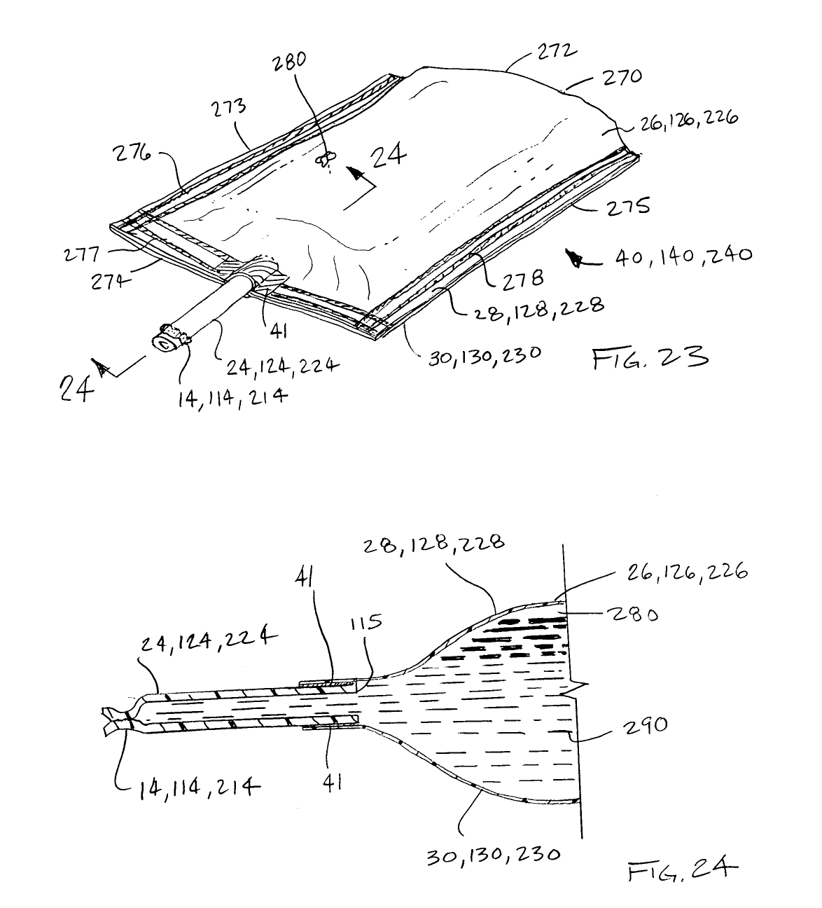

The flexible bags 40, 140, 240 produced using the preferred apparatus 18, 118, 218 in accordance with the invention are generally the same and include a directly connected dispensing tube 24, 124, 224 that is connected under aseptic conditions. The bag 40, 140, 240 is shown in detail in FIGS. 23 and 24. The bag 40, 140, 240 is formed of a polymeric film having two wall portions 28, 30; 128, 130; 228, 230 overlying one another and preferably connected together via a fold 270 which forms a common connected, non-seamed edge 272. A plurality of other common peripheral edges 273, 274, 275 are fused together to form edge seams 276, 277, 278. The edge seams 276, 277, 278 may be single fused areas or two spaced apart fused areas, as shown in FIG. 23. The wall portions 28, 30; 128, 130; 228, 230, the edge seams 276, 277, 278 and the non-seamed edge 272 define an interior space 280 of the bag 40, 140, 240. Alternatively, two separate films that overly one another could be utilized and seams formed on all edges.

The sterile tube segment 24, 124, 224, which has an open end (commonly designated 115), is inserted between the two wall portions of the bag film 26, 126, 226 along one of the common peripheral edges 274 and secured thereto by a fused area 41 (also shown in FIG. 2), which is created under aseptic conditions. The open end 115 of the tube segment 24, 124, 224 is in communication with the bag interior space 280 and the closed end of the tube segment 24 is located outside of the bag film 26. As noted above, the edge seam 277 which forms the fin seal can be formed at the same time as the wall portion-to-tube segment seal at fused area 41, such as by using the heat sealing jaws 184′, 186′.

In the preferred form, fill and seal operation, a food product 290 (FIG. 24) is placed in the bag 40, 140, 240, prior to heat sealing a final one of the common peripheral edges. In the preferred embodiments, the tube segment 24, 124, 224 is an irradiated thermoplastic elastomer, which is preferably formed from polypropylene. The tube segment 24, 124, 224 is preferably irradiated with at least 30 kGY to improve bonding to the bag film 26, 125, 226. It is also possible to form the tube segments 24, 124, 224 from a blend of polyethylene and polypropylene in order to change the adhesion properties to enhance adhesion to the bag film 26, 126, 226. One preferred tube segment is formed from KRATON, which is a registered trademark of Kraton Polymers, LLC, which is blended with other materials, such as polypropylene, to make the tube.

Alternatively, the tube segments 24, 124, 224 could be formed from multi-layer tubing 12, 112, 212 so that the tube segments 24, 124, 224 contain a barrier layer, such as EVOH, to create barrier properties similar to that of the bag film 26, 126, 226.

The bag film 26, 126, 226 preferably comprises at least one of EVOH, olefin, LDPE (low-density polyethylene), LLDPE, ULDPE and PET. The bag film 26, 126, 226 may also be a multilayer bag film including at least one layer formed of one of the above materials. However, generally any suitable polymeric, flexible film material may be used to make the bag, depending upon the particular application. In the preferred embodiment, the edge seams and the fused joint are heat fused. However, those skilled in the art will recognize that other fusion methods may be utilized, such as ultrasonic or laser.

The apparatus 18, 118, 218 in accordance with the invention can be used to carry out a method of attaching a tube to a bag 40, 140, 240 by fusion during manufacture in an aseptic form, fill and seal operation. A bag film 26, 126, 226 is provided, having two wall portions 28, 30; 128, 130; 228, 230 for forming a bag 40, 140, 240 with an interior space. A sterile tube segment 24, 124, 224 having an open end is provided and is inserted with the open end between the wall portions 28, 30; 128, 130; 228, 230. The tube segment 24, 124, 224 is fused to the bag film 26, 126, 226 with the open end of the tube segment 24, 124, 224 in communication with the interior space. This is done in an aseptic environment and the resulting fused area provides a hermetic seal between the tube segment 24, 124, 224 and the bag 40, 140, 240.

In accordance with the invention, it is also possible to feed tubing 12, 112 from a supply through a sterilizing area and into a sterile environment, such as that provided by the tube sterilization chamber 20 feeding into the sterile processing chamber 42. The tube segment 24 is then cut from a free end of tubing 12.

Alternatively, as disclosed in conjunction with the apparatus 118, the outside of the tubing 112 can be sterilized in a hydrogen peroxide bath 121, as shown in FIG. 4. The tubing 112 is then dried using the dryer 123 located downstream of the bath. The tubing 12, 112, 212 can be provided by unwinding it from a roll on an unwind stand 109 or maybe fan folded or provided in a coiled arrangement, or in any other form suited for dispensing.

In accordance with the invention, the fin seal for the edge of the bag can be performed at the same time and with the same heat sealing jaws 184′, 186′ as the heat sealing of the tube segment 124 between the bag wall portions 128, 130. Preferably, prior to completing a final edge seal, a viscous food product or other product is placed within the interior space of the bag prior to the final edge of the bag being sealed in order to create a sealed bag with a viscous or semi-viscous product therein. The bag 40, 140, 204 is formed, filled and sealed in a totally aseptic environment and without the need for an additional fitment for connection of the dispensing tube 24, 124, 224 to the bag.

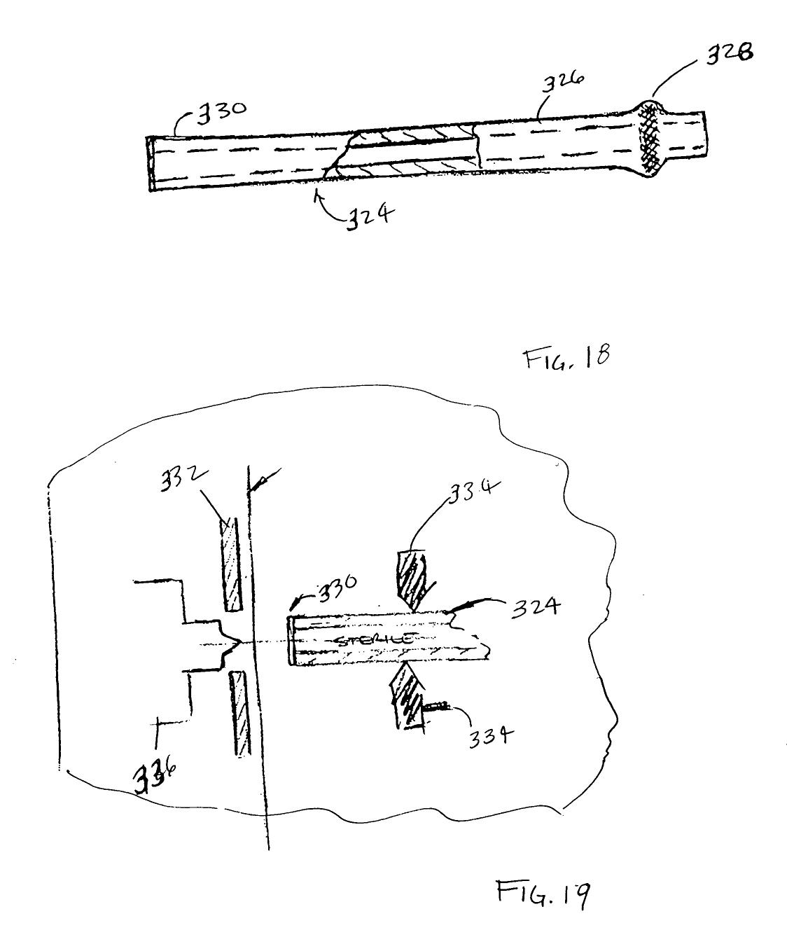

Referring now to FIGS. 18 and 19, an alternate method of attaching a dispensing tube segment to a flexible bag or pouch will be described in detail. In FIG. 18, a tube segment assembly 324 is shown. The tube segment assembly 324 includes a length of tube 326, similar to the tubing described in the first embodiment. One end of the tube 326 is sealed shut, preferably by heat crimping, as shown as 328. The other end is sealed with a patch 330, made of an appropriate bag material compatible polymeric material. Preferably, the patch 330 is made of LDPE. The tube assemblies 324 are produced in batches and then irradiated to sterilize the internal surfaces. This can be done with UV, H₂O₂ or any other appropriate means.

Referring now to FIG. 19, a tube applicator 334 places an individual tube assembly 324 in position within a sterile area. The applicator 334 pushes the patch end of the tube assembly against a shaped, heated mandrel 336 located on the opposite side of the bag film 338 used to make the bags or pouches. The heated mandrel 336 pierces the patch 330 and heat seals the tube assembly 324 to the bag film 338. The patch 330 is selected to be compatible with the bag film 328 to provide enhanced sealing of the tube to the bag.

The remainder of the bag forming, filling and sealing process can be carried out aseptically using the known equipment.

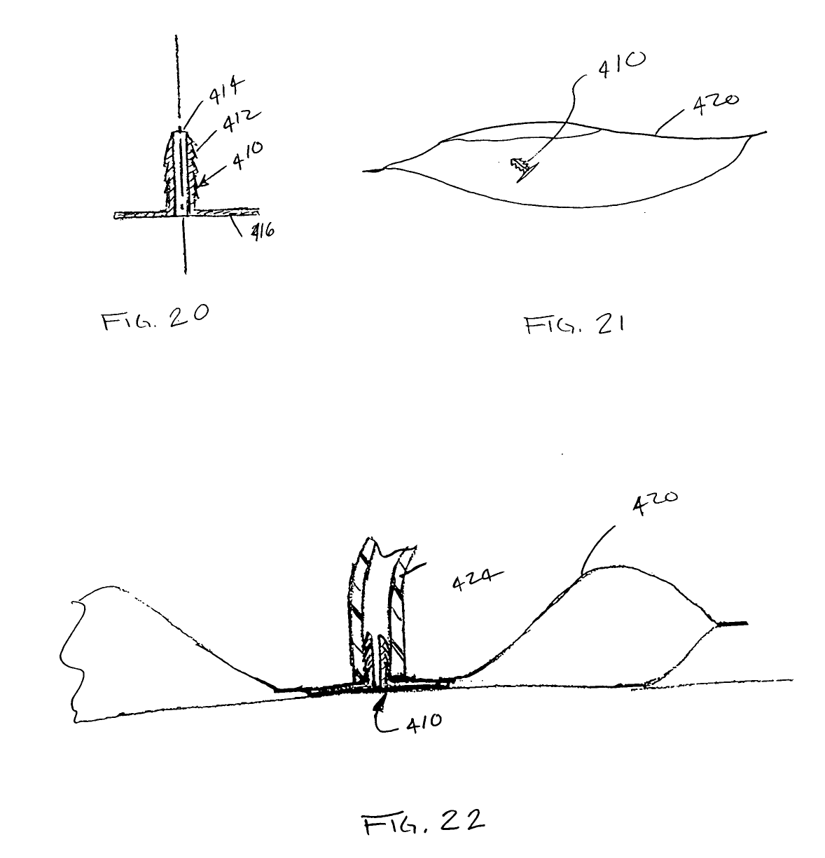

Another alternative method of attaching a tube to a sealed pouch will be described with reference to FIGS. 20-22. A barbed fitment 410 is shown in FIG. 20 that has barbs 412 located on a hollow stem 414 that extends upwardly from a flat base 416. The fitment 410 is sterilized and delivered to the bag or pouch 420, shown in FIG. 21, as it is being filled with a viscous or semi-viscous product.

When a user desires to use the bag 420 and dispense the material therein, the bag 420 is laid on a generally flat surface, and the fitment is manipulated through the flexible bag sidewalls so that the stem 414 is pointed upwardly, and the flat base 416 is oriented downwardly so that it rests on the generally flat surface. The fitment 410 is moved to a desired location, and a dispensing tube 424 is then pressed over the barbed stem 414, causing the film to locally rupture allowing the stem 414 to stick through the bag sidewall as the tube 424 is pressed over the stem. The end of the tube 424 being pressed over the stem can have an enlarged flange so that the bag sidewall is captured between the flat base 416 of the fitment 410 and the flange. Additionally, an adhesive can be provided on the flange to seal to the bag surface. Alternatively, a knife can be used to pierce the bag sidewall at the stem location prior to pushing the tube 424 onto the stem 414.

It will be recognized by those skilled in the art, that changes may be made to the above described embodiments of the invention without departing from the broad inventive concept thereof. It is understood, therefore, that this invention is not limited to the particular embodiments disclosed, but that it is intended to cover all modifications which are within the spirit and scope of the invention.

What is claimed is:

1. An apparatus for attaching a tube segment to a bag by fusing them together in an aseptic form, fill and seal operation, comprising:
a sterile processing chamber in which a sterilized tube segment and a pair of opposing wall portions of a bag film to form a flexible bag are to be located, the sterilized tube segment having an open end, the opposing wall portions defining an interior space therebetween;
a tube inserter at least partially located within the processing chamber and arranged to grip the tube segment and place the tube segment between the wall portions of the bag film in the sterile processing chamber; and
at least one member for fusing the tube segment between the wall portions of the bag film so that the open end of the tube segment is in communication with the interior space in the bag.

2. The apparatus of claim 1, further comprising:
a tube sterilization chamber in which tubing from a supply of tubing is introduced, the tube sterilization chamber being in communication with the sterile processing chamber.

3. The apparatus of claim 2, wherein the tube sterilization chamber includes a hydrogen peroxide bath.

4. The apparatus of claim 3, further comprising a dryer located downstream of the bath.

5. The apparatus of claim 4, wherein the dryer comprises a heated sterile air supply.

6. The apparatus of claim 3, further comprising a plurality of rollers located in the bath, the tubing extending between the rollers to provide a desired dwell time to ensure sterility.

7. The apparatus of claim 2, wherein the tube sterilization chamber is at least one of a hydrogen peroxide vapor chamber, a hydrogen peroxide bath, an ultraviolet radiation chamber, an ion radiation chamber, or a high intensity pulsed light chamber.

8. The apparatus of claim 1, further comprising a hydrogen peroxide vapor generator connected to the sterile processing chamber that feeds hydrogen peroxide vapor into the chamber.

9. The apparatus of claim 8, wherein the hydrogen peroxide vapor is at least at a 31% concentration.

10. The apparatus of claim 1, further comprising a tube supply unwind stand with a supply of tubing.

11. The apparatus of claim 10, wherein the unwind stand includes a brake to keep tension on the tubing.

12. The apparatus of claim 10, wherein the supply of tubing includes pre-crimped, irradiated tubing so that an inside of the tubing is sterile.

13. The apparatus of claim 10, wherein supply of tubing comprises tubing crimped only at each end, the apparatus further comprising at least one pre-heat section to preheat a portion of the tubing, and a crimper located downstream of the preheater to crimp the tubing into sealed tube segments.

14. The apparatus of claim 10, further comprising:
a cutter located in a sterile area in or in communication with the sterile processing chamber to cut the tube segment from the supply of tubing.

15. The apparatus of claim 14, wherein the tube cutter comprises opposing blades that are driven together to cut the tubing into tube segments.

16. The apparatus of claim 15, wherein the opposing blades mounted to at least one rotary actuator, swing toward one another to cut the tubing.

17. The apparatus of claim 14, wherein the supply of tubing is pre-crimped, and the apparatus further comprises a crimp position sensor in proximity to the tube cutter, the crimp position sensor being adapted to detect a position of the crimp to allow a location of cut to be positioned adjacent to the crimp.

18. The apparatus of claim 14, wherein the tube cutter is mounted for movement by an actuator to adjust a position of the tube cutter based on a crimp in the tubing.

19. The apparatus of claim 14, wherein the cutter is pre-heated.

20. The apparatus of claim 10, further comprising opposing drive wheels to grip and pull the tubing from the supply of tubing.

21. The apparatus of claim 20, further comprising a dancing bar located in a path of the tubing, the dancing bar is moveable between upper and lower positions, and a sensor connected to the dancing bar which signals the drive wheels to feed additional tubing when the dancing bar approaches the upper position.

22. The apparatus of claim 10, wherein the inserter comprises opposing jaws that are moveable toward one another to grip an end of tubing from the supply of tubing prior to the tubing being cut from the supply of tubing to form the tube segment.

23. The apparatus of claim 22, wherein the opposing jaws are moveable toward and away from the bag film.

24. The apparatus of claim 23, wherein the opposing jaws are moved linearly by linear actuators connected to the jaws to insert the open end of the tube segment between the sides of the bag film.

25. The apparatus of claim 1, further comprising a bag film splitter that separates the opposing wall portions of the bag film from one another at a tube insertion site prior to the inserter placing tube segment in position.

26. The apparatus of claim 25, wherein the bag film splitter comprises two arms joined in a V-shaped arrangement that moves from a first position, in which only a first part of the arms at a base of the V are located between the opposing wall portions of the bag film so that the bag wall portions are not separated, to a second position, in which spaced apart ends of the arms are moved between and separate the wall portions to allow insertion of the tube segment.

27. The apparatus of claim 1, wherein the at least one member is arranged to provide ultrasonic energy to the open end of the tube located between the wall portions of said bag.

28. The apparatus of claim 1, wherein the at least one member comprises at least one sealing jaw for heat sealing the open end of the tube segment between the wall portions of the bag film.

29. The apparatus of claim 28, wherein there are two opposed heat sealing jaws which include a recess complementary to and smaller than a diameter of the tube segment.

30. The apparatus of claim 29, wherein the heat sealing jaws include a fin seal for an edge of the bag.

31. The apparatus of claim 30, wherein the heat sealing jaws each include a plurality of heating zones that are controlled independently to provide a different heat sealing temperature in an area of a seal between the bag wall portions to form a bag edge seam than an area of a seal between the bag wall portions and the tube segment.

32. The apparatus of claim 31, wherein the heat sealing jaws are heated to 350-450° F. for heat sealing the bag wall portions to the tube segment, and from 250-350° F. for heat sealing the bag wall portions together to form the bag edge seam.

33. The apparatus of claim 29, wherein the heat sealing jaws are moveable from a first, non-contact position, away from the bag film, to a second, sealing position, in contact with the bag film, to seal the tube segment between the wall portions of the bag film.

34. The apparatus of claim 29, wherein the heat sealing jaws include a tube sealing recess with a flattened profile having a circumference that is smaller than a circumference of the tube segment.

35. The apparatus of claim 29, further comprising a controller to control a tube cut position, a tube feed rate, a temperature of heat sealing jaws and a sealing time.

36. The apparatus of claim 1, wherein tubing from a tubing supply is introduced into the sterile processing chamber, the apparatus further comprising a pressure sensor to determine if a sterile environment in the sterile processing chamber is breached, and a tubing crimper which crimps the tubing upon the pressure sensor detecting a loss of pressurization to maintain sterility of the tube supply.

37. A flexible bag with a directly connected dispensing tube connected under aseptic conditions, comprising:
a polymeric bag formed of a polymeric film having two wall portions overlying one another and connected together via a fold which forms a common connected, non-seamed edge, and a plurality of other common peripheral edges which are fused together to form edge seams, the wall portions, the edge seams and the non-seamed edge defining an interior space of the bag; and
a sterile tube segment having an open end, inserted between the two wall portions of the film along one of the common peripheral edges and secured thereto by a fused joint created under aseptic conditions, the open end of the tube being in communication with the interior space, the tube having a closed end, located outside of the film.

38. The bag of claim 37, wherein a food product is placed in the bag prior to heat sealing a final one of the common peripheral edges.

39. The bag of claim 37, wherein the tube segment is an irradiated thermoplastic elastomer.

40. The bag of claim 37, wherein the tube segment is formed from polypropylene.

41. The bag of claim 37, wherein the tube segment is irradiated with at least 30 kGy to improve bonding to the film.

42. The bag of claim 37, wherein the tube segment comprises a blend of polyethylene and polypropylene.

43. The bag of claim 37, wherein the tube segment comprises KRAYTON.

44. The bag of claim 37, wherein the bag film comprises at least one of EVOH, Olefin, LDPE, LLDPE, ULDPE and PET.

45. The bag of claim 37, wherein the bag film is multilayer, and includes a layer of at least one of EVOH, Olefin, LDPE, LDPE, ULDPE and PET.

46. The bag of claim 37, wherein the edge seams and the fused joint are heat fused.

47. A method of attaching a tube to a bag by fusion during manufacture in an aseptic form, fill and seal operation, comprising:
providing a film having two wall portions for forming a bag with an interior space;
providing a sterile tube segment having an open end;
inserting the open end of the tube segment between the wall portions; and
fusing the tube segment to the film with the open end of the tube in communication with the interior space.

48. The method of claim 47, further comprising:
feeding tubing through a sterilizing area into a sterile environment; and
cutting the tube segment from a free end of the tubing.

49. The method of claim 48, further comprising:
sterilizing an outside of the tubing in a hydrogen peroxide bath; and
drying the tubing with a dryer located downstream of the bath.

50. The method of claim 49, further comprising:
feeding the tubing through a plurality of rollers located in the bath to provide a desired dwell time to ensure sterility.

51. The method of claim 48, further comprising:
feeding hydrogen peroxide vapor into the sterilizing area to sterilize an outside of the tubing.

52. The method of claim 48, further comprising:
sterilizing an outside of the tubing using at least one of a hydrogen peroxide vapor chamber, a hydrogen peroxide bath, an ultraviolet radiation chamber, an ion radiation chamber, or a high intensity pulsed light chamber.

53. The method of claim 48, further comprising:
unwinding the tubing from a roll on an unwind stand; and
applying tension to the tubing.

54. The method of claim 48, further comprising:
supplying the tubing with a plurality of evenly spaced apart crimps, such that the tubing includes a plurality of sealed, sterile inner segments.

55. The method of claim 48, further comprising:
providing the tubing crimped only at each end and having a single sterile inner volume;
preheating a portion of the tubing; and
crimping an end segment of the tubing to form a separate, sealed tube segment.

56. The method of claim 48, further comprising:
preheating the cutter for cutting the tube segment.

57. The method of claim 48, further comprising:
supplying the tubing with a plurality of evenly spaced apart crimps, such that the tubing includes a plurality of sealed, sterile inner segments;
sensing a position of a crimp for the last tubing segment;
adjusting a location of the cut so that the tubing is cut adjacent to the crimp.

58. The method of claim 48, further comprising:
gripping and pulling the tubing from a tube supply using opposing drive wheels:
sensing an amount of slack tubing using a dancing bar located along a path of the tubing; and
feeding additional tubing when the dancing bar approaches an upper position.

59. The method of claim 48, wherein the method produces a plurality of bags in sequence, the method further comprising:
gripping a free end of the tubing with opposing gripper jaws prior to cutting the tube segment to be inserted into a next bag from the tubing, the tube segment to be inserted into a next bag being produced.

60. The method of claim 59, further comprising:
linearly moving the opposing jaws with the tube segment toward the film.

61. The method of claim 47, further comprising:
separating the wall portions in an insertion area prior to insertion of the tube segment.

62. The method of claim 47, wherein the fusing takes place by heat sealing.

63. The method of claim 62, wherein the step of heat sealing includes:
providing heat sealing jaws with a recess complementary to and smaller than a diameter of the tube segment;
pre-heating the heat sealing jaws; and
moving the heat sealing jaws into contact with the film from opposing sides with the tube segment located in a complementary position to the recess.

64. The method of claim 63, further comprising:
forming a fin seal for an edge of the bag with the heat sealing jaws simultaneously with heat sealing the tube segment between the bag sides.

65. The method of claim 63, further comprising:
moving the heat sealing jaws from a first, non-contact position, away from the film, to a second, sealing position in contact with the film to seal the tube segment between the sides of the bag; and
moving the heat sealing jaws back to the first position to allow the bag to index forward to a next station.

66. The method of claim 47, further comprising:
filling the bag with a viscous or semi-viscous product prior to sealing a final one of the edges.

67. A method of attaching a tube to a bag, comprising placing a barbed fitment into the bag prior to sealing the bag;
locating the fitment in the bag;
pressing a tube over the fitment so that the fitment extends through the a sidewall of the bag.
